(19) United States
(12) Patent Application Publication
(10) Pub. No.: US 2009/0308373 A1
(43) Pub. Date: Dec. 17, 2009

(54) Portable Insulated Grill

(75) Inventors: Leon James Scott, Atlanta, GA (US); Jeffrey Travis Stout, Symrna, GA (US); Michael James Carlson, Atlanta, GA (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: IN ZONE, INC., Smyrna, GA (US)

(21) Appl. No.: 12/139,895

(22) Filed: Jun. 16, 2008

(51) Int. Cl. A47J 37/07; B65D 43/14; B65D 81/38; F23H 13/00

(52) U.S. Cl. 126/25 R; 220/810; 220/592.22; 126/152 B

(57) ABSTRACT

A portable insulated grill has a housing and a lid, both of which have inner and outer shells of metal with a plenum therebetween filled with an insulating material such as fiberglass. A hinge couples the lid to the housing, and a tube is attached on the bottom of the housing. The grill can be carried on a carrier or on a vehicle. The carrier has a support surface, wheels, and a leg. A bar connected to the support surface extends toward an open side. This bar can removably position in the tube on the bottom of the housing so the support surface can support the grill. As an alternative, the grill's tube can mount on a drawbar attached to a hitch on a vehicle. Inside the grill, the housing has brackets that support a firebox on a first shelf and that support a main grate either on the first shelf or on a second shelf. The main grate has cutaways and can be locked in position by the brackets when positioned on the second shelf. An auxiliary grate has a stand that can connect to the main grate and that allows the auxiliary grate to rotate.

### CROSS-REFERENCE TO RELATED APPLICATIONS

This application is filed concurrently with co-pending U.S. Design Appl. Ser. No. 29/319,831 and entitled “Portable Grill,” which is incorporated herein by reference in its entirety.

### BACKGROUND

Ceramic Kamado style grills, such as the Big Green Egg® and grills available from Primo® Grills and Smokers, are very efficient because they have low heat loss and fuel usage. (BIG GREEN EGG is a registered trademark of Edward R. Fisher, and PRIMO is a registered trademark of Primo Ceramics, LLC.). As a result, the food when cooked in these grills retains its moisture and oils. The insulating properties of their thick ceramic walls, which can be from 0.75 to 1-inch thick, significantly contribute to the efficiency of these grills. Although their cooking benefits are well known, these grills are quite heavy, expensive, and not portable, and they are vulnerable to damage. Therefore, these Kamado style grills are typically mounted in a permanent stand on a patio, or they may be placed on a stand with casters that allows the grills limited mobility.

In contrast to limited mobility of Kamado style grills, other grills known in the art are more portable. These grills typically have a thin metal housing, such as the Weber Ranch® Kettle grill that has a porcelain-enameled bowl and lid of plated steel. (RANCH is a registered trademark of Weber-Stephen Products Co.). These portable types of grills can also have a stand with wheels for rolling the grills.

A common problem with portable grills is finding space to transport it with a vehicle. After cooking at an event, for example, a user often wants to quickly transport the portable grill but would prefer not put the grill inside the vehicle because the grill is too large, dirty, oily, or hot. Some specialty grills can be mounted for transport and use on a vehicle's trailer hitch receptacle. One such specialty grill manufactured by The Freedom Grille mounts to a vehicle's 2″ trailer hitch for transport and can be “swing-out” on a pivoting arm for use without unhitching from the vehicle. (FREEDOM GRILL is a registered trademark of Steven J. Caliguri.).

### BRIEF DESCRIPTION OF THE DRAWINGS

FIG. 1A is a perspective view of a portable insulated grill according to certain teachings of the present disclosure.

FIG. 1B is a cross-sectional view of the grill with the lid opened.

FIG. 2 is a cross-sectional view of the grill with the lid closed.

FIGS. 3A-3B are cross-sectional views of the grill's housing.

FIGS. 4A-4B are top and cross-sectional views of the grill's firebox.

FIG. 5A is a perspective view of the grill with the lid opened showing inside the grill and firebox.

FIG. 5B is a perspective view of the grill with the lid opened showing the lower grate in a locked positioned in the housing.

FIG. 5C is a perspective view of the grill with the lid opened showing the top grate pivoted on the lower grate.

FIG. 6 shows the grill and a hitch drawbar.

FIG. 7A shows the grill used on a carrier.

FIG. 7B is a top view of the carrier.

FIG. 7C shows features of the grill and the carrier of FIG. 7A.

FIG. 8A is a bottom view of the handle, tray, and drawer for the grill.

FIG. 8B is a cross-sectional view of the handle and tray for the grill.

### DETAILED DESCRIPTION

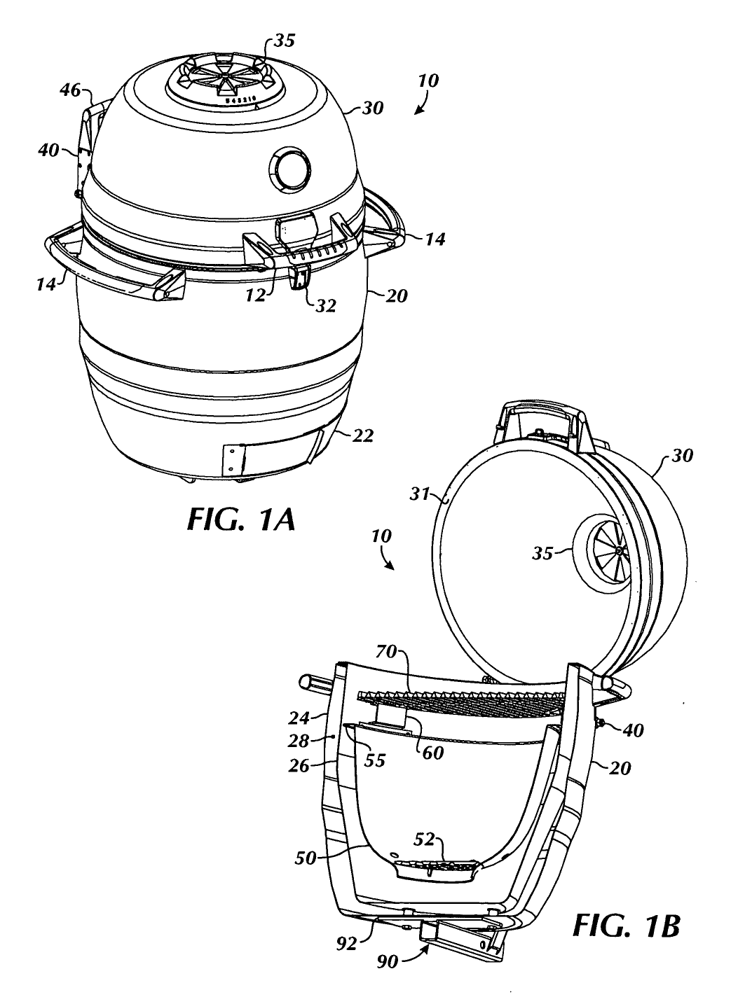

A portable insulated grill 10 illustrated in FIGS. 1A-1B has a housing 20 with a lid 30 connected thereon by a hinge mechanism 40. As shown in FIG. 1A, the lid 30 has a latch 32 for securing the lid 30 closed to the housing 20. The lid 30 also has an upper chimney vent 35 that can be turned to increase or decrease the airflow therethrough. As also shown in FIG. 1A, the housing 20 has a lower draft door 22 that can regulate airflow through the grill 10 when used in conjunction with the lid's vented chimney 35.

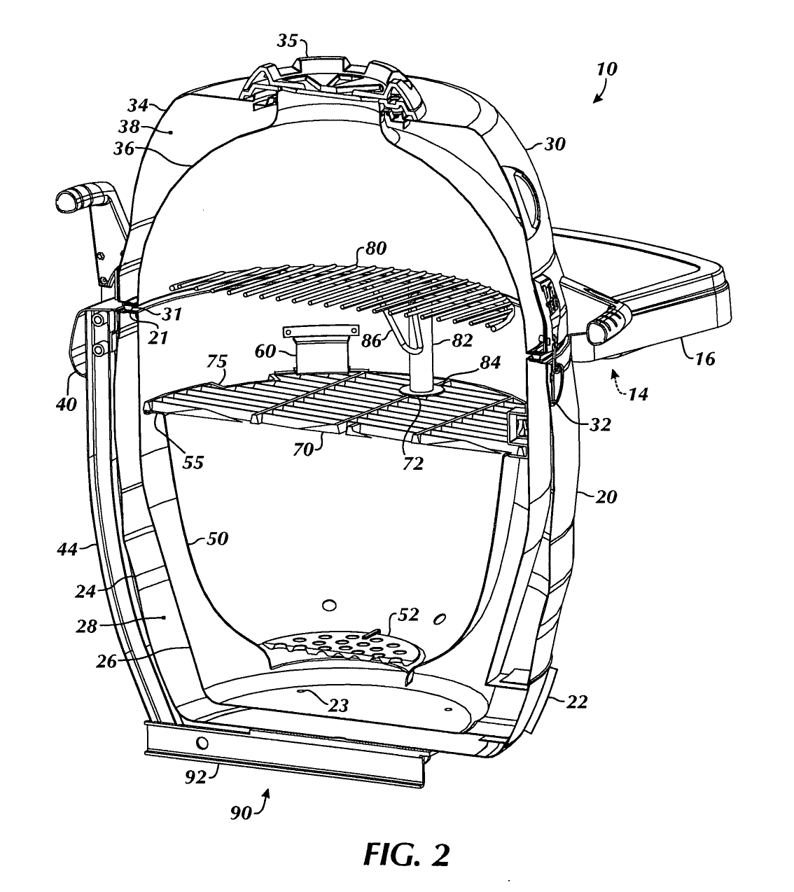

On the outside of the grill 10, a front handle 12 on the lid 30 can be used to open and close the lid 30, and side handles 14 on the housing 20 can be used for moving and lifting the grill 10. The front handle 12 can have the added feature of an integral bottle opener or openers. As shown in other figures herein (e.g., FIG. 2), removable side trays (16) can attach onto these side handles 14 during use and can be removed for transport. As best shown in FIG. 1B, a mounting system attaches to the bottom of the housing 20 and includes a receiver tube 90 attached to a base plate 92 that in turn bolts to the bottom of the housing 20.

As also shown in FIG. 1B, the grill's housing 20 has an insulated construction with an outer shell 24 and an inner shell 26 with a plenum 28 therebetween. The plenum 28 can be merely filled with air insulating the shells 24 and 26. Preferably, the plenum 28 is at least partially filled with an insulating material (not shown), such as a fiberglass insulation or the like. Within the insulated housing 20, a firebox 50 has an upper rim 55 that is supported on brackets 60 in the housing 20. The bottom of the firebox 50 has a grate 52 for supporting a solid fuel such as charcoal or the like and for allowing airflow from the draft door 22 and spent ash to pass through the grate 52. Above the firebox 50, a main (lower) grate 70 also positions on the bracket 60 for cooking.

Further details of the grill 10 are shown in FIG. 2. As noted previously, the insulated construction of the housing 20 includes the outer shell 24 surrounding the inner shell 26 with the plenum 28 therebetween, which is again shown in FIG. 2. At the bottom of the housing 20, supports 23 separate the bottom of the housing's inner shell 26 from the outer shell 24. These supports 23 also have threaded points for connecting the base plate 92 to the bottom of the outer shell 24.

As with the housing 20, the lid 30 also has an outer shell 34 surrounding an inner shell 36 with a plenum 38 therebetween as part of the grill's insulated construction. Each of these shells 24/26/34/36 can be composed of mild carbon steel, stainless steel, or the like. The plenums 28/38 are filled with an insulating material (not shown), such as fiberglass insulation or the like, further enhancing the insulated construction of the grill 10.

With the insulated construction, the inner steel shells 26/36 are thermally isolated from the outer steel shells 24/34 by the plenum 28/38 and the insulating material, and only small contact points are provided where the shells 24/26 and 34/36 meet. For example, the housing's shells 24/26 meet at limited contact points at the upper rim, at the supports 23, and the passage to the draft door 22. Similarly, the lid's housings 34/36 meet at limited contact points at the lid's rim and at the vent 35. As a result, the grill 10 can operate very efficiently with low fuel usage and can offer cooking benefits similar to ceramic Kamado style grills. Moreover, the outer shells 24/34 of the grill 10 during use can remain at a relatively low temperature. In this way, the handles 12/14 can be made from plastic, such as Nylon 6/6, and can mount directly against the outer steel shells 24/34.

Although it is insulted and offers good insulating properties, the grill 10 is considerably more portable than ceramic Kamado style grills. In particular, the steel shells 24/34 and 26/36 with insulating material form composite walls on the grill 10 that are strong and durable, yet much lighter than ceramic. Moreover, being insulated, the grill 10 offers better cooking benefits than conventional portable grills having porcelain-enameled bowl and lid of plated steel. For example, the grill 10's composite wall construction can be as thermally efficient or greater than a ceramic Kamado style grill while being significantly less heavy and much more rugged. As an added benefit, the majority of the outside surfaces of the grill 10 remain much cooler than common portable grills, making it safer to use and ready for transport relatively soon after cooking.

Further details inside the grill 20 are also shown in FIG. 2. Within the housing 20, the firebox 50 remains separated from the inner shell 26 except for its rim 55 supported on the brackets 60. In this way, the firebox 50, which can be composed of steel, holds charcoal, wood chips, or other fuel away from the inner shell 26. Also at the bottom of the housing 20, the draft door 22 is shown covering an opening in the outer shell 24 and communicating directly with the inner shell 22. Any spent coals and ash that fall through the grate 52 can be cleaned-out through the draft doors 22 using a hook shaped ash tool so that the firebox 50 does not need to be removed to clean out the ashes. However, the firebox 50 and grate 52 can be removed for replacement or cleaning.

Also in the housing 20, the main grate 70, which is preferably composed of cast iron, positions above the firebox 50 and can be set at two different cooking heights on the brackets 60. As shown previously in FIG. 1B, for example, the main grate 70 can position at the top of the brackets 60. As shown in FIG. 2, the main grate 70 can position at the bottom of the brackets 60 against the rim 55 of the firebox 50. To mount in this lower position, the main grate 70 has a plurality (three) peripheral cutouts 75 that can pass over the brackets 60. Additionally and as discussed in more detail below, the main grate 70 can be turned to misalign the cutouts 75 and lock the grate 70 in its lowest position for transport.

Above the main grate 70, an auxiliary (top) grate 80 can be used for smoking, baking, and other kinds of cooking above the main grate 70. The top grate 80, which is preferably composed of porcelain coated steel wire, has a downward extending stand 82 with a flange 84, and the stand 82 positions in an opening 82 in the main grate 70. In this way, the auxiliary grate 80 can rotate about this off-center stand 72 and can “swing out” to allow access to the main grate 70. A wire support 86 on the top grate 80 allows a user to rotate the grate 80 into or out of cooking position using a spatula or other cooking utensil.

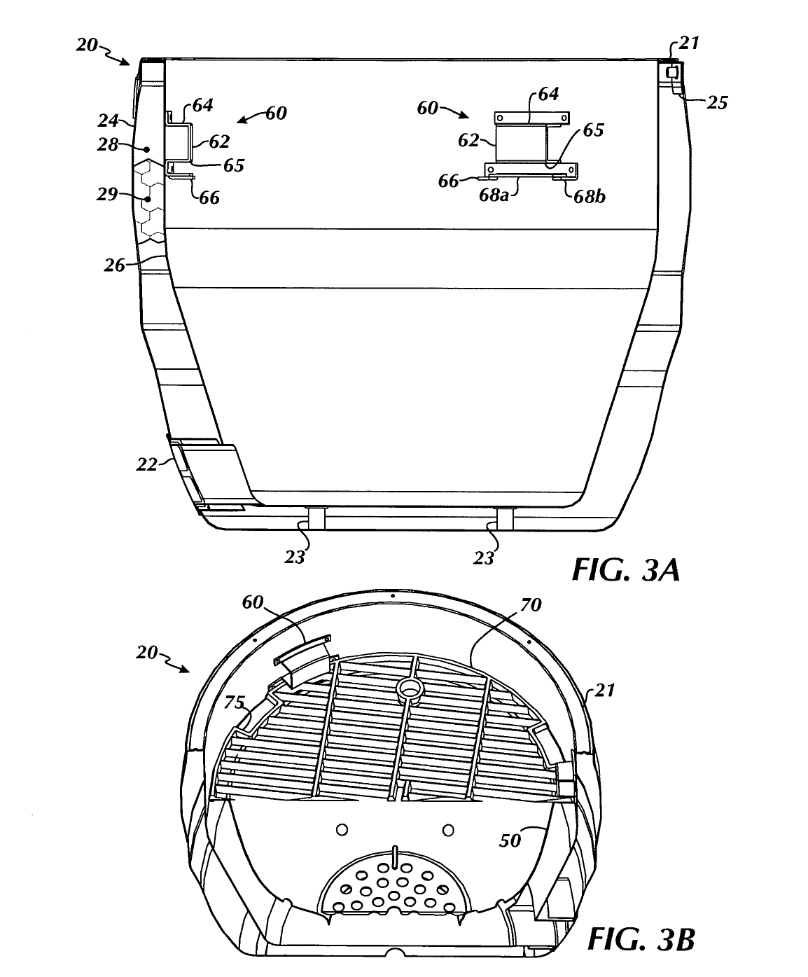

Further details of the housing 20 and the brackets 60 are shown in FIGS. 3A-3B. As shown, portion of the insulating material 29 fills the plenum 28 between the inner and outer shells 24/26. The housing's outer shell 24 may actually be composed of several portions that connect together at one or more folds.

The brackets 60 fasten to the inner shell 26 with rivets or the like. Each bracket 60 has a projecting face 62 with an upper shelf 64 and a lower stop 65. Each bracket 60 also has a lower shelf 66 below the face 62. This lower shelf 66 has a raised center portion 68a with lower ends 68b on which the firebox 50 is supported. As discussed previously, the main grate (70) can be supported on the upper shelf 64 as in FIG. 1B or on the lower shelf 66 (i.e., on center 68a) as in FIG. 2, and the firebox (50) is supported on the lower shelf 66 (i.e., on ends 68b).

As further shown in FIGS. 3A-3B, a gasket 21 is disposed about the rim of the housing 20 where the inner and outer shells 24/26 come together. Preferably, this gasket 21 is a flat fiberglass gasket that thermally isolates the inner and outer shells 24/26 at the point where they come together at the rim. As shown in FIG. 2, the housing's gasket 21 mates with an opposing gasket 31 on the rim of the lid 30. The lid's gasket 31 preferably has an internal spring of stainless steel and has an outer jacket of silicon impregnated fiberglass.

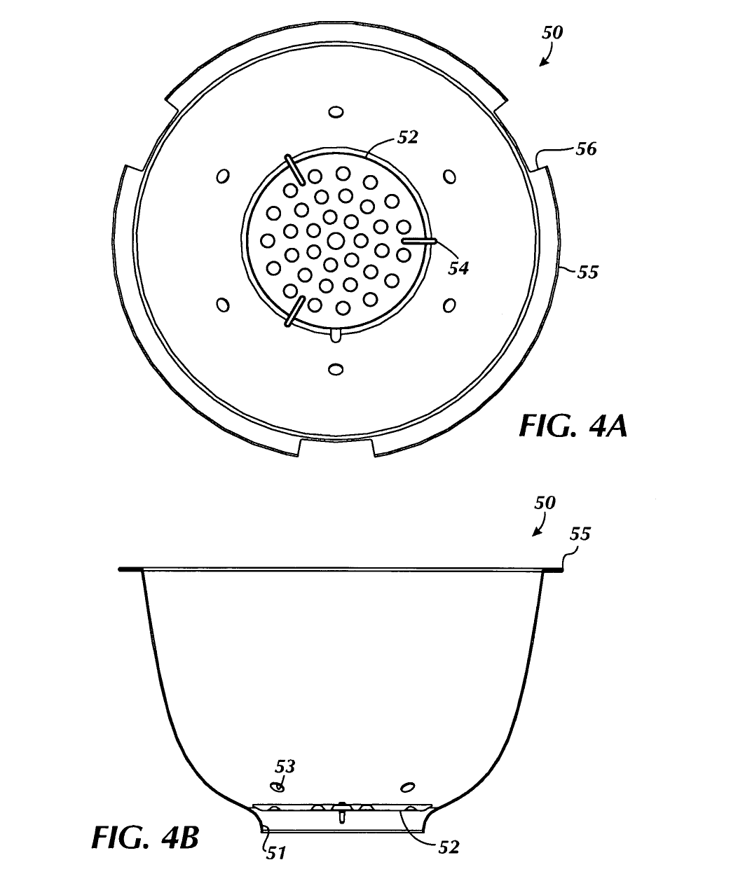

The firebox 50 is shown in isolated views in FIGS. 4A-4B. The firebox 50 has a lower opening 51 surrounded by vent holes 53. The bottom grate 52 rests on a plurality of outward extending fingers 54 over the lower opening 51. The geometry and shape of the firebox 50 and charcoal grate 52 as well as the diameter and placement of the vent holes 53 are all configured to facilitate heat and fire control in the grill 10.

As with the cooking grates 70/80, the firebox 50 is also removable from the housing 20 for cleaning or replacement. For support, the firebox 50 has the surrounding rim 55 with a plurality of peripheral cutouts 56. These cutouts 56 are sized to fit over the projecting face (62) of the bracket (60) so that the portions of the rim 55 can be supported on the lower shelf (66) (See FIG. 3A). The raised centers (68a) of the lower shelves (66) position in the peripheral cutouts 56 to lock the firebox 50 by preventing it from rotating in the housing 20.

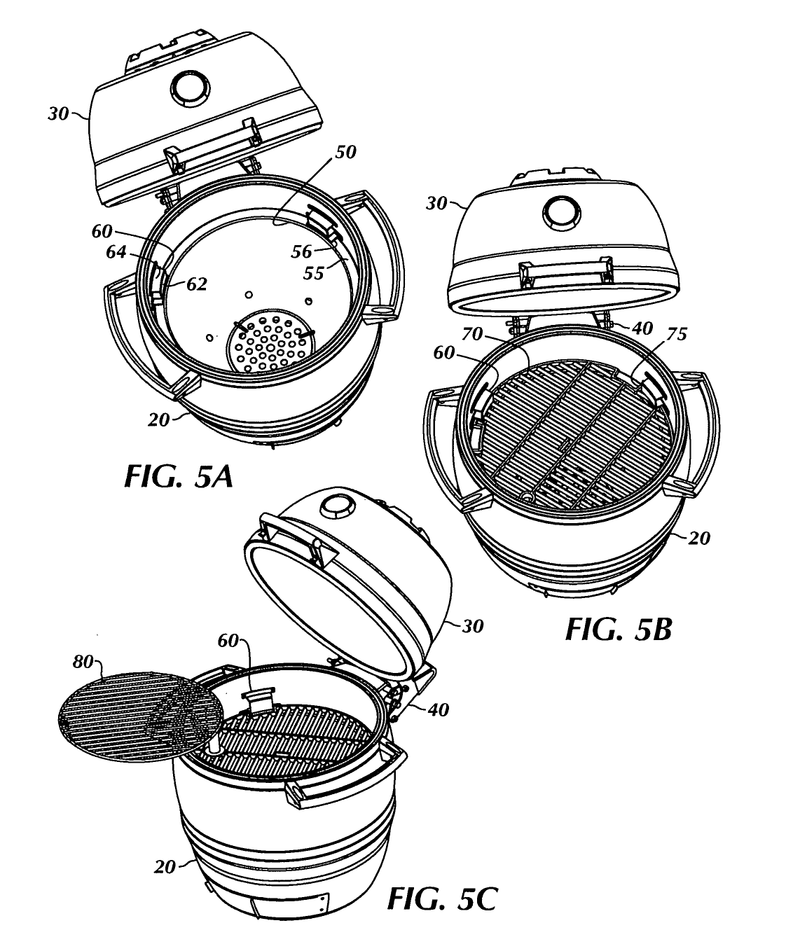

Details for setting up the grill 10 for use are shown in FIGS. 5A-5C. As shown in FIG. 5A, the firebox 50 and bottom grate 52 are positioned in the housing 20 with the cutouts 55 passing over the projecting faces 62 and top shelf 64 of the brackets 60 so that the rim 55 rests on the lower shelf (66). The user charges the firebox 50 with charcoal or the like. Then, the user positions the main grate 70 in the housing 20 on either the top shelf 64 or bottom shelf 66. To position on the lower shelf 66, the user aligns the peripheral cutouts 75 on the grate 70 with the brackets 60 and sets the main grate 70 on the rim 55 of the firebox 50. To lock the grate 70 in place, the user turns the main grate 70 to misalign the cutouts 75 with the brackets 60. This allows the grill 10 to be moved and tilted without the main grate 70 and firebox 50 becoming loose within the housing 20. Finally, the user can position the auxiliary grate 80's stand 82 in the opening of the main grate 70. As shown in FIG. 5C, the auxiliary grate 80 can be pivoted on the stand 82 to expose the main grate 70 below.

As evidenced herein, the grill 10 is more portable than ceramic grills that mount in permanent or semi-mobile stands and is more portable than specialty grills that mount on swing-out bars on a trailer hitch of a vehicle. In particular, the grill 10 can be transported on a vehicle's trailer hitch and can be dismounted from the hitch and placed on a carrier to be moved to a desired location. After use, the grill 10 can be removed from the carrier and remounted on the trailer hitch for transport.

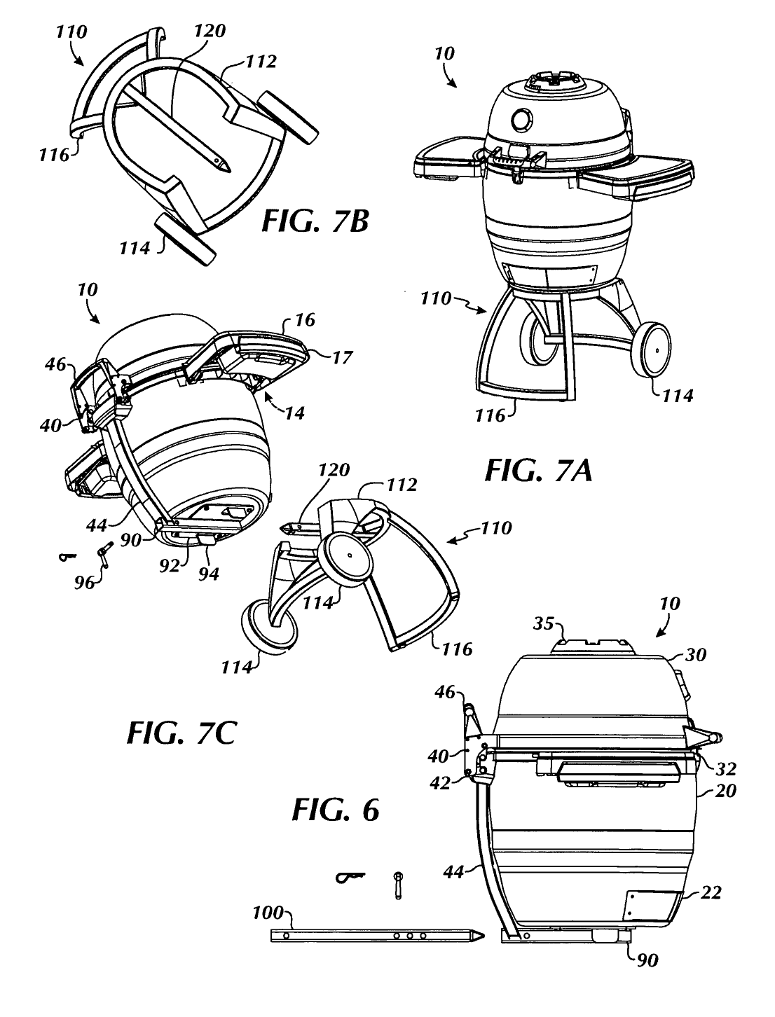

Details of the portability of the grill 10 are provided in FIGS. 6 and 7A-7C. As shown in FIG. 6, the receiver tube 90 at the bottom of the grill 10 can fit directly on a drawbar 100 that in turn can mount to a 1.25″ or 2″ trailer hitch (not shown) on a vehicle. To mount the grill 10 on the drawbar 100, two people lift the grill 10 and slide it onto the drawbar 100. Then, a screw-in locking pin locks the grill 10 in place. Depending on the application, the grill 10 can be slid onto the drawbar 100 either facing forward or backward. Preferably, the back end of the receiver tube 90 inserts onto the drawbar 100 on the vehicle hitch so that the front of the grill 10 faces away from the vehicle, allowing the grill 10 to be opened while mounted on the vehicle.

Being mountable on the drawbar 100, the grill 10 can be transported with the vehicle to a location. While on the hitch, the grill 10 can be opened, cleaned, or prepared for grilling. In addition, the grill 10 can be dismounted from the drawbar 100 and positioned on a carrier 110 as shown in FIG. 7A for moving the grill 10 about. As best shown in FIG. 7B, the carrier 110 has a frame 112 supported on a pair of wheels 114 and a leg 116. A drawbar 120 extends from the frame 112 towards an open side. As shown in particular in FIG. 7C, the drawbar 120 removably inserts into the receiver tube 90 attached to the base plate 92 on the bottom of the housing 20. The tube 90 locks onto the drawbar 120 by a locking pin 96 to hold the grill 10 on the carrier 110. The base plate 92 may have legs 94 that allow the grill 10 to stand temporarily on a flat surface when removed from the carrier 110 but not yet installed on the drawbar 100 of the vehicle. The front end of the receiver tube 90 inserts onto the drawbar 120 so that the front of the grill 10 faces leg 116.

Once positioned on the carrier 110, the grill 10 can be set up and used for grilling. When done, users can then remove the grill 10 from the carrier 110 and remount the grill 10 on the drawbar 100 connected to the vehicle's trailer hitch to transport the grill 10. This portability allows the grill 10 to be shutdown and quickly attached to the vehicle for transport even when the grill 10 is still warm. For this form of portable transport, components of the grill 10 can be removed and locked in place while being transported. Internally, for example, the main cooking grate 70 can be lowered and rotated to lock the internals of the grill 10. Then, the side trays 16 having drawers 17 can be removed and stored in the vehicle. For attachment, these trays 16 can snap fit onto the handles 14, or they can use removably fasteners or the like. Finally, the lid 30 can be latched shut to the housing 20 by latch 32.

Many provisions have been made to assure that the disclosed grill 10 can withstand loads and vibrations while mounted to the vehicle's trailer hitch. These included the grill's dual shell construction with insulating material, an external spine 44 and hinge mechanism 40, the latch 32, the lock-down of the cooking grate 70, and the ability to seal the chimney 35 and draft doors 22 shut. When locked for transport, the main grate 70 is pressed against the firebox 50 and holds each component from movement or excessive vibration that could cause damage to the components or the inside of the grill 10.

The latch 32 between the housing 20 and the lid 30 located on the front of the grill 10 works with the hinge mechanism 40 to secure the lid 30 closed when the grill is moved. Additionally, the gasket 31 on the lid 30 (See FIG. 2) is compressed enough to create a seal between the housing 20 and lid 30. If the latch 32, chimney 35, and draft doors 22 are all closed or locked, then the grill 10 is substantially sealed and can be transported even with live coals.

The spine 44 provides a robust mounting structure for the portable grill 10 that allows it to withstand shock and vibration when hitched to a vehicle. For structural integrity, for example, the external spine 44 interconnects the receiver tube 90 to the hinge 40. At the bottom of the grill, the external spine 44 is welded to the receiver 90, which in turn is welded to base plate 92. This plate 92 bolts with spacers into nuts affixed to the inner shell 26 of the housing 20. Along the side of the grill 10, the external spine 44 screws into a steel bracket or plate 25 (See e.g., FIG. 3A) internally in the outer shell 24 of the housing 20. At the lid 30, the hinge mechanism 40 couples to the spine 44 by linkages 42 that operate the opening and closing of the lid 30 on the housing 20. The hinge mechanism 40 screws into another steel bracket or plate (not shown) internally in the outer shell 34 of the grill's lid 30. The hinge mechanism 40 has its own back handle 46 that can be used to roll the grill 10 when installed onto the carrier 112 and can be used to carry and move the grill 10.

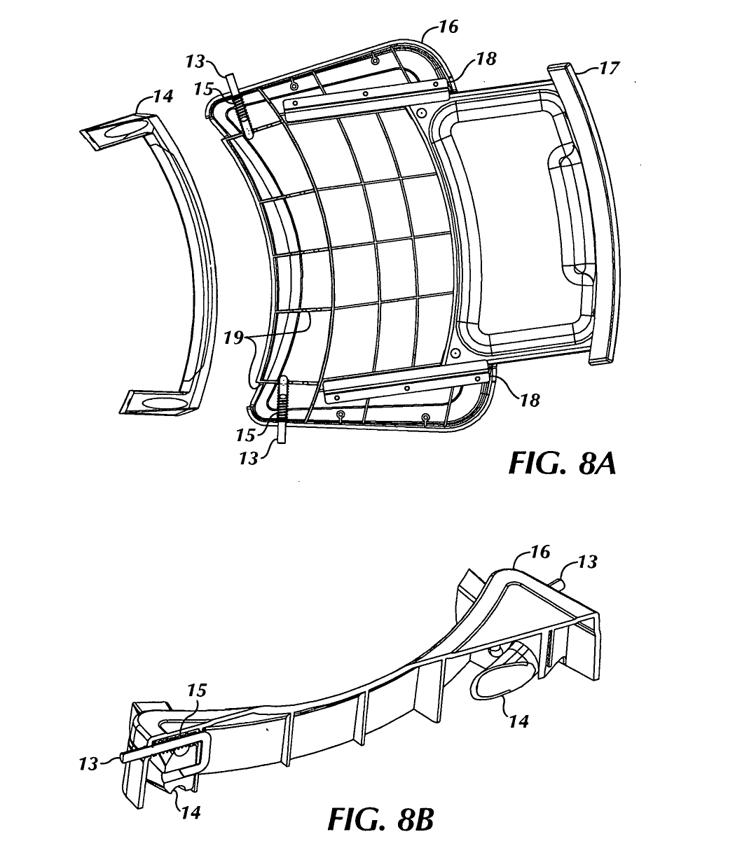

As noted above, the side trays 16 can have drawers 17 and can be removed from the handles 14. As shown on the bottom of the tray 16 in FIG. 8A, the drawer 17 can slide on side brackets 18. In addition, the tray 16 has an open track 19 along its bottom surface into which the handle 14 can fit when the tray 16 positions on the handle 14. Push pins 13 biased by springs 15 installed in the sides of the tray 16 releasably fasten the tray 16 to the handle. In particular and as shown in FIG. 8B, the curved ends of the push pins 13 insert into holes in the handle 14 to hole the tray 16 to the handle 14. To release the tray 16, a user simply pushes the exposed portion of the pins 13 against the bias of the springs 15 to remove the curved portion of the pins 13 from the holes in the handle 14 so that the tray 16 can be lifted from the handle 14.

The portable insulated grill 10 of the present disclosure has ornamental features shown and described in co-pending U.S. Design Pat. Appl. Ser. No. 29/319,831 and entitled “Portable Grill”, which is incorporated herein by reference in its entirety.

The foregoing description of preferred and other embodiments is not intended to limit or restrict the scope or applicability of the inventive concepts conceived of by the Applicants. For example, the portable grill 10 can be constructed with rugged shells 24/34/26/36 and without an external spine 44. In addition, the portable grill 10 can be constructed with a removable lid 20 that does not use a hinge mechanism 40 to connect to the housing 20. Moreover, even though the portable grill 10 has been described for use with the firebox 50 and solid fuel, such as charcoal or the like, other embodiments of the insulated portable grill 10 may use gas as the heat source. In such an arrangement, gas burners can be supported inside the chamber of the housing 20 away from the inner shell 26, and an appropriate gas line can communicate outside the housing 20 and can connect to a valve and gas tank commonly used in the art.

In exchange for disclosing the inventive concepts contained herein, Applicants desire all patent rights afforded by the appended claims. Therefore, it is intended that the appended claims include all modifications and alterations to the full extent that they come within the scope of the following claims or the equivalents thereof.

What is claimed is:

1. A portable grill, comprising:
a housing having a first inner shell disposed within a first outer shell and having a first plenum therebetween;
a first insulating material at least partially filling the first plenum;
a lid having a second inner shell disposed within a second outer shell and having a second plenum therebetween;
a second insulating material at least partially filling the second plenum; and
a hinge coupling the lid to the housing.

2. The grill of claim 1, wherein the first or second insulating material comprises a fiberglass material.

3. The grill of claim 1, wherein the first inner and outer shells comprise a metal material.

4. The grill of claim 1, wherein the housing comprises a first rim having a first gasket, and wherein the lid comprises a second rim having a second gasket.

5. The grill of claim 4, wherein the first gasket comprises a fiberglass material thermally isolating the first inner and outer shells at the first rim.

6. The grill of claim 4, wherein the second gasket comprises an internal spring and an outer jacket of silicon impregnated fiberglass.

7. The grill of claim 1, further comprises a plurality of brackets disposed on an inside surface of the first inner shell of the housing.

8. The grill of claim 1, further comprising a firebox removably positionable in the first inner shell of the housing, the firebox having a rim supportable on the brackets.

9. The grill of claim 8, wherein the rim defines a plurality of cutaways, and wherein each of the brackets has a shelf with a raised portion, the rim fitting onto the first shelves and the raised portions disposed in the cutaways.

10. The grill of claim 1, further comprising a first grate removably positionable in the first inner shell of the housing, the first grate having a periphery supportable on the brackets.

11. The grill of claim 10, wherein each of the brackets has a first shelf and a second shelf separated from one another, and wherein the periphery of the first grate defines a plurality of peripheral cutaways similarly sized and alignable with the first shelves.

12. The grill of claim 11, wherein the first grate is positionable in a first position supported on the first shelves of the brackets and in a second position supported on the second shelves.

13. The grill of claim 11, wherein each of the brackets has a projecting surface between the first and second shelves, the projecting surface engaging a top portion of the first grate when rotated relative to the brackets and supported on the second shelves.

14. The grill of claim 10, wherein the first grate defines an opening therein, and wherein the grill further comprises a second grate having a stand rotatably connectable to the opening in the first grate.

15. The grill of claim 1, wherein the first outer shell defines an opening communicating with the inside of the first inner shell.

16. The grill of claim 15, wherein a movable door covers the opening.

17. The grill of claim 1, wherein the housing comprises a pair of housing extending from the outer shell, and wherein the grill comprise a pair of shelves removably attachable to the handles.

18. A portable grill, comprising:
a housing having a first inner shell disposed within a first outer shell and having a first plenum therebetween;
a first insulating material at least partially filling the first plenum;
a lid;
a hinge coupling the lid to the housing; and
a tube attached outside the housing, the grill supportable by the tube.

19. The grill of claim 18, further comprising a spine disposed outside the housing and interconnecting the tube and the hinge.

20. The grill of claim 18, wherein the hinge comprises a linkage connecting the lid to the housing.

21. The grill of claim 18, further comprising a bar removably insertable into the tube and connectable to a trailer hitch on a vehicle.

22. The grill of claim 18, further comprising a carrier having a support surface and a bar, the bar removably insertable in the tube, the housing supportable on the support surface.

23. The grill of claim 18, wherein the lid comprises a second inner shell disposed within a second outer shell and having a second plenum therebetween, a second insulating material at least partially filling the second plenum.

24. A portable grill, comprising:
a housing;
a lid;
a hinge coupling the lid to the housing;
a tube attached outside the housing; and
a carrier having a support surface and a bar, the bar removably insertable in the tube, the housing supportable on the support surface.

25. The grill of claim 24, wherein the carrier comprises one or more wheels connected to the support surface.

26. The grill of claim 24, wherein the carrier comprises at least one leg connected to the support surface.

27. The grill of claim 24, further comprising a spine disposed outside the housing and interconnecting the tube and the hinge.

28. The grill of claim 24, wherein the support surface has a central opening with an open side, the bar extending in the central opening substantially parallel to the support surface, the bar having a distal end extending toward the open side of the support surface.

29. The grill of claim 24, wherein the housing comprises a first inner shell disposed within a first outer shell and having a first plenum therebetween, a first insulating material at least partially filling the first plenum.

30. The grill of claim 29, wherein the lid comprises a second inner shell disposed within a second outer shell and having a second plenum therebetween, a second insulating material at least partially filling the second plenum.

31. The grill of claim 24, wherein the housing comprises a pair of handles extending from the outer shell, and wherein the grill comprise a pair of shelves removably attachable to the handles.

32. A portable grill, comprising:
a housing having a first chamber with a first open end, the housing having a first inner shell disposed within a first outer shell and having a first plenum therebetween;
a lid having a second chamber with a second open end, the lid having a second inner shell disposed within a second outer shell and having a second plenum therebetween;
a hinge coupling the lid to the housing and permitting the second open end of the lid to open and close relative to the first open end of the housing; and
a tube attached outside the housing, the grill supportable by the tube.

33. The grill of claim 32, further comprising a spine disposed outside the housing and interconnecting the tube and the hinge.

34. The grill of claim 32, wherein the hinge comprises a linkage connecting the lid to the housing.

35. The grill of claim 32, further comprising a bar removably insertable into the tube and connectable to a trailer hitch on a vehicle.

36. The grill of claim 32, further comprising a carrier having a support surface and a bar, the bar removably insertable in the tube, the housing supportable on the support surface.

37. The grill of claim 32, further comprising an insulating material at least partially filling the first and second plenums.

38. The grill of claim 32, wherein the housing comprises a pair of handles extending from the outer shell, and wherein the grill comprise a pair of shelves removably attachable to the handles.
